(19) United States
(12) Patent Application Publication
(10) Pub. No.: US 2026/0199179 A1
(43) Pub. Date: Jul. 16, 2026

(54) Adult Sex Toy and Stimulation Method for Enhancing Sexual Stimulation

(71) Applicant: Zhuo ZENG, Shenzhen (CN)

(72) Inventor: Zhuo ZENG, Shenzhen (CN)

(21) Appl. No.: 19/015,668

(22) Filed: Jan. 10, 2025

(51) Int. Cl. A61H 19/00; A61H 9/00; A61H 23/02

(52) U.S. Cl. CPC A61H 19/32; A61H 9/0057; A61H 23/0254; A61H 2201/1246; A61H 2201/5051; A61H 2201/5097; A61H 2205/087

(57) ABSTRACT

Disclosed is an adult sex toy for enhancing sexual stimulation. The adult sex toy is internally provided with a vagina-shaped inner cavity, one end of the inner cavity is provided with an opening for receiving a male genital organ, and the other end of the inner cavity is provided with an air pump assembly for providing an intermittent flow of the air between the ambient atmosphere outside the adult sex toy and the inner cavity; and the air pump assembly is configured to provide the inner cavity with a certain air pressure for releasing air into or sucking the air from the inner cavity, thereby compressing or decompressing the inner cavity to stimulate the male genital organ therein.

### TECHNICAL FIELD

The present disclosure generally relates to adult sex toys, also known as sex toys, and in particular to an adult sex toy implemented to stimulate male genital organs.

### BACKGROUND

An adult sex toy (or a sex toy) is an object or device primarily used to promote human sexual pleasure, and is generally resemble the human genitalia. People are increasingly accepting sexual behaviors and masturbation, which has promoted the development of the adult sex toy market. For example, male masturbation is often performed by using adult sex toys that cause friction and further help people achieve arousal. Male masturbators in the adult sex toys have long been known. In particular, these types of adult sex toys generally have one shape or one opening into which a male genital organ is inserted to create a sexual stimulus. We also know that the adult sex toys can reproduce an effect similar to sexual intercourse by replicating the effect of the penetration movement of the penis. This effect is usually recreated by elastic elements located on the open limbs of the male masturbator.

One of the most common male masturbators is a cylindrical container which can stimulate the male genital organ inserted thereinto by effects such as friction and vibration. However, the known adult sex toys generally cannot accurately simulate actual sexual intercourse. In particular, an element having a simulated vaginal inner cavity cannot provide a consistent pressure on all areas of the male genital organ inserted thereinto, and is therefore unsatisfactory to a user.

### SUMMARY

In view of the shortcomings of the prior art, the present disclosure aims to provide an adult sex toy and stimulation method for enhancing sexual stimulation, which can make a man feel similar to real sexual intercourse by using an inner cavity having a shape similar to the vagina to create an air pressure.

In order to achieve the above purpose, the present disclosure adopts the following technical solutions.

An adult sex toy for enhancing sexual stimulation is internally provided with a vagina-shaped inner cavity, one end of the inner cavity is provided with an opening for receiving a male genital organ, and the other end of the inner cavity is provided with an air pump assembly for providing an intermittent flow of the air between the ambient atmosphere outside the adult sex toy and the inner cavity; and the air pump assembly is configured to provide the inner cavity with a certain air pressure for releasing air into or sucking the air from the inner cavity, thereby compressing or decompressing the inner cavity to stimulate the male genital organ therein.

It should be noted that the air pump assembly includes an air pump, an air pump head and an electromagnetic air valve, the air pump head is disposed at the other end of the inner cavity, and an air vent is reserved in the air pump head and is configured to release air into the inner cavity or suck the air from the inner cavity; one end of the air pump is connected to the air pump head, and the other end of the air pump is communicated with the ambient atmosphere; one end of the electromagnetic air valve can be intermittently communicated between the air pump head and the air pump, and the other end of the electromagnetic air valve is communicated with the ambient atmosphere; when the air pump sucks the air from the inner cavity through the air vent of the air pump head, an interior of the inner cavity is in a compressed state; and after the electromagnetic air valve is turned on, the ambient atmosphere can enter the inner cavity through the air vent of the air pump head, so that the interior of the inner cavity returns to a decompressed state.

It should be noted that when the air pump is in a working state, the inner cavity is in an air-sucked state, and the electromagnetic air valve is in an off state; and when the electromagnetic air valve is in a working state, the air pressure of the inner cavity is the same as that of the ambient atmosphere, and the air pump is in an off state.

It should be noted that the adult sex toy further includes a vibration motor, and the vibration motor is disposed at one side of the inner cavity to make an inner wall of the inner cavity vibrate, thus stimulating the male genital organ in the inner cavity.

It should be noted that the adult sex toy further includes a controller for controlling the on or off of the air pump assembly and the on or off of the vibration motor. The controller can also be used to control the suction force of the air pump, so as to control the air suction volume of the inner cavity; and the controller can also be used to control the vibration frequency of the vibration motor.

It should be noted that the controller includes a remote control signal receiving module and a Bluetooth/WIFI signal module, and the controller can receive a control signal by means of the remote control signal receiving module or the Bluetooth/WIFI signal module, so as to control the on or off of the air pump assembly and the on or off of the vibration motor.

It should be noted that the inner cavity is made of one or more thermoplastic elastomers.

According to the adult sex toy provided above, the present disclosure also provides a method for improving sexual stimulation, and the method includes:
receiving, by the controller, the control signal;
the received control signal being turning on or off the air pump assembly or turning on or off the vibration motor;
when the control signal is turning on or off the air pump assembly, releasing air into or sucking the air from the inner cavity by the air pump assembly; and
when the control signal is turning on or off the vibration motor, starting or stopping the vibration motor.

It should be noted that the control signal may come from a remote control signal, a Bluetooth signal, or a WIFI signal.

It should be noted that when the air pump assembly is turned on, the suction force of the air pump can be controlled by the control signal, and the air suction volume of the inner cavity is controlled by the suction force, so that the inner wall of the inner cavity can achieve different compression effects.

It should be noted that the vibration frequency of the vibration Motor Can Be Controlled By The Control Signal.

The present disclosure has the beneficial effect that the inner wall of the inner cavity can be deformed by the air pump assembly, so that the male genital organ in the inner cavity can be extruded, and the real sexual intercourse experience can be further simulated.

### BRIEF DESCRIPTION OF FIGURES

FIG. 1 is a schematic diagram of a structure of the present disclosure.

FIG. 2 is a schematic diagram of the air pump assembly of the present disclosure.

### DETAILED DESCRIPTION

The present disclosure will be further described below in conjunction with the accompanying drawings. It should be noted that the following embodiment is based on the technical solutions, and provides detailed implementations and specific operation processes, but the protection scope of the present disclosure is not limited to this embodiment.

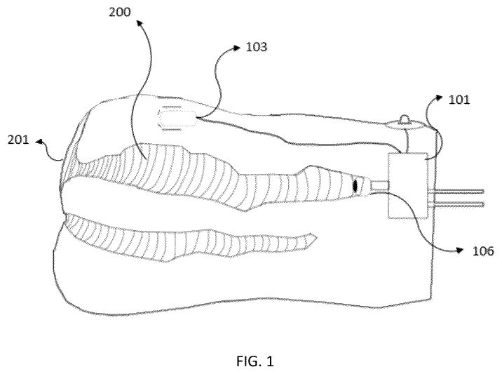

As shown in FIG. 1, an adult sex toy for enhancing sexual stimulation is internally provided with a vagina-shaped inner cavity, one end of the inner cavity 200 is provided with an opening 201 for receiving a male genital organ, and the other end of the inner cavity 200 is provided with an air pump assembly for providing an intermittent flow of the air between the ambient atmosphere outside the adult sex toy and the inner cavity 200; and the air pump assembly is configured to provide the inner cavity 200 with a certain air pressure for releasing air into or sucking the air from the inner cavity 200, thereby compressing or decompressing the inner cavity 200 to stimulate the male genital organ therein.

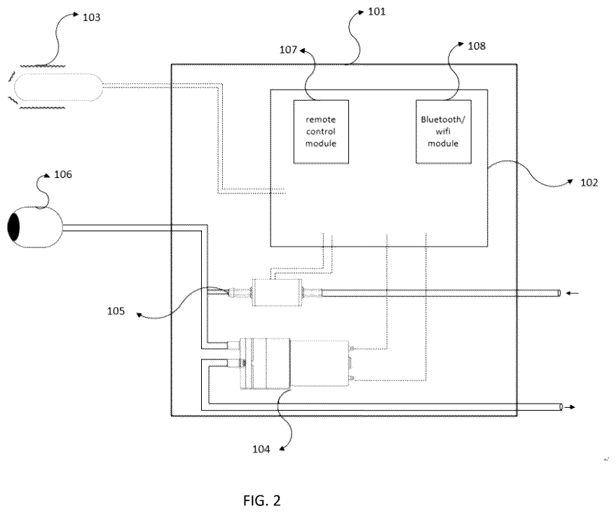

Further, as shown in FIG. 2, the air pump assembly of the present disclosure includes an air pump 104, an air pump head 106 and an electromagnetic air valve 105, the air pump head 106 is disposed at the other end of the inner cavity, and an air vent is reserved in the air pump head 106 and is configured to release air into the inner cavity or suck the air from the inner cavity; one end of the air pump 104 is connected to the air pump head 106, and the other end of the air pump 104 is communicated with the ambient atmosphere; one end of the electromagnetic air valve 105 can be intermittently communicated between the air pump head 106 and the air pump 104, and the other end of the electromagnetic air valve 105 is communicated with the ambient atmosphere.

Further, when the air pump 104 sucks the air from the inner cavity through the air vent of the air pump head 106, an interior of the inner cavity is in a compressed state; and after the electromagnetic air valve 105 is turned on, the ambient atmosphere can enter the inner cavity through the air vent of the air pump head 106, so that the interior of the inner cavity returns to a decompressed state.

In order to keep the state of the inner cavity stable after air suction, when the air pump is in a working state, the inner cavity is in an air-sucked state, and the electromagnetic air valve is in an off state.

Secondly, when the electromagnetic air valve is in a working state, the air pressure of the inner cavity is the same as that of the ambient atmosphere, and the air pump is in an off state.

Further, as shown in FIG. 2, the present disclosure further includes a vibration motor 103, and the vibration motor 103 is disposed at one side of the inner cavity to make an inner wall of the inner cavity vibrate, thus stimulating the male genital organ in the inner cavity. It should be pointed out that the vibration motor and the air pump assembly in the present disclosure work independently, that is, when the air pump assembly is working, the vibration motor can be turned on at the same time.

Further, as shown in FIG. 1, the present disclosure further includes a controller 102 for controlling the on or off of the air pump assembly and the on or off of the vibration motor 103.

In order to meet different users'needs for different degrees of extruding the male genital organ, the controller 102 of the present disclosure can also be used to control the suction force of the air pump 104, so as to control the air suction volume of the inner cavity; when the maximum air suction volume is reached, the pressure of the inner wall of the inner cavity on the male genital organ is the maximum; and similarly, the controller can also be used to control the vibration frequency of the vibration motor.

Further, as shown in FIG. 2, the controller 102 includes a remote control signal receiving module 107 and a Bluetooth/WIFI signal module 108, and the controller 102 can receive a control signal by means of the remote control signal receiving module 107 or the Bluetooth/WIFI signal module 108, so as to control the on or off of the air pump assembly and the on or off of the vibration motor.

It should be pointed out that the remote control signal receiving module 107, the Bluetooth/WIFI signal module 108 and the air pump assembly can be placed in a main control box 101 during actual use, as shown in FIG. 2.

Further, the inner cavity of the present disclosure is made of one or more thermoplastic elastomers.

In actual use, the specifical steps of the present disclosure may be:
receiving, by the controller, the control signal;
the received control signal being turning on or off the air pump assembly or turning on or off the vibration motor;
when the control signal is turning on or off the air pump assembly, releasing air into or sucking the air from the inner cavity by the air pump assembly; and
when the control signal is turning on or off the vibration motor, starting or stopping the vibration motor.

Specifically, the control signal may come from a remote control signal, a Bluetooth signal, or a WIFI signal.

Specifically, when the air pump assembly is turned on, the suction force of the air pump can be controlled by the control signal, and the air suction volume of the inner cavity is controlled by the suction force, so that the inner wall of the inner cavity can achieve different compression effects. The vibration frequency of the vibration motor can be controlled by the control signal.

For those skilled in the art, various corresponding changes and variations can be given according to the above technical solutions and concepts, and all these changes and variations should be included within the protection scope of the claims of the present disclosure.

What is claimed is:

1. An adult sex toy for enhancing sexual stimulation, being internally provided with a vagina-shaped inner cavity, and one end of the inner cavity being provided with an opening for receiving a male genital organ, wherein the other end of the inner cavity is provided with an air pump assembly for providing an intermittent flow of the air between the ambient atmosphere outside the adult sex toy and the inner cavity; and the air pump assembly is configured to provide the inner cavity with a certain air pressure for releasing air into or sucking the air from the inner cavity, thereby compressing or decompressing the inner cavity to stimulate the male genital organ therein.

2. The adult sex toy for enhancing the sexual stimulation according to claim 1, wherein the air pump assembly comprises an air pump, an air pump head and an electromagnetic air valve, the air pump head is disposed at the other end of the inner cavity, and an air vent is reserved in the air pump head and is configured to release air into the inner cavity or suck the air from the inner cavity; one end of the air pump is connected to the air pump head, and the other end of the air pump is communicated with the ambient atmosphere; one end of the electromagnetic air valve can be intermittently communicated between the air pump head and the air pump, and the other end of the electromagnetic air valve is communicated with the ambient atmosphere; when the air pump sucks the air from the inner cavity through the air vent of the air pump head, an interior of the inner cavity is in a compressed state; and after the electromagnetic air valve is turned on, the ambient atmosphere can enter the inner cavity through the air vent of the air pump head, so that the interior of the inner cavity returns to a decompressed state.

3. The adult sex toy for enhancing sexual stimulation according to claim 2, wherein when the air pump is in a working state, the inner cavity is in an air-sucked state, and the electromagnetic air valve is in an off state; and when the electromagnetic air valve is in a working state, the air pressure of the inner cavity is the same as that of the ambient atmosphere, and the air pump is in an off state.

4. The adult sex toy for enhancing sexual stimulation according to claim 2, further comprising a vibration motor, and the vibration motor is disposed at one side of the inner cavity to make an inner wall of the inner cavity vibrate, thus stimulating the male genital organ in the inner cavity.

5. The adult sex toy for enhancing sexual stimulation according to claim 2, further comprising a controller for controlling the on or off of the air pump assembly and the on or off of the vibration motor, wherein the controller can also be used to control the suction force of the air pump, so as to control the air suction volume of the inner cavity; and the controller can also be used to control the vibration frequency of the vibration motor.

6. The adult sex toy for enhancing sexual stimulation according to claim 5, wherein the controller comprises a remote control signal receiving module and a Bluetooth/WIFI signal module, and the controller can receive a control signal by means of the remote control signal receiving module or the Bluetooth/WIFI signal module, so as to control the on or off of the air pump assembly and the on or off of the vibration motor.

7. The adult sex toy for enhancing sexual stimulation according to claim 1, wherein the inner cavity is made of one or more thermoplastic elastomers.

8. A method for enhancing sexual stimulation by using the adult sex toy of claim 1, comprising:
receiving, by the controller, the control signal;
the received control signal being turning on or off the air pump assembly or turning on or off the vibration motor;
when the control signal is turning on or off the air pump assembly, releasing air into or sucking the air from the inner cavity by the air pump assembly; and
when the control signal is turning on or off the vibration motor, starting or stopping the vibration motor.

9. The method for enhancing sexual stimulation according to claim 8, wherein the control signal may come from a remote control signal, a Bluetooth signal, or a WIFI signal.

10. The method for enhancing sexual stimulation according to claim 8, wherein when the air pump assembly is turned on, the suction force of the air pump can be controlled by the control signal, and the air suction volume of the inner cavity is controlled by the suction force, so that the inner wall of the inner cavity can achieve different compression effects.

11. The method for enhancing sexual stimulation according to claim 8, wherein the vibration frequency of the vibration motor can be controlled by the control signal.
